(19) United States
(12) Patent Application Publication
(10) Pub. No.: US 2019/0248050 A1
(43) Pub. Date: Aug. 15, 2019

(54) POSITIONING MODULE AND MOLD INSERT THEREOF

(71) Applicants: Guangzhou Lite-on Mobile Electronic Components Co., Guangzhou (CN); LITE-ON TECHNOLOGY CORPORATION, TAIPEI CITY (TW)

(72) Inventors: Paramashiva Muniswamy, Guangzhou (CN); Ku-Yuan Huang, Taichung City (TW); Lixian Peng, Shenzhen (CN)

(21) Appl. No.: 16/046,444

(22) Filed: Jul. 26, 2018

(30) Foreign Application Priority Data
Feb. 13, 2018 (CN) 201810150375.4

(51) Int. Cl. B29C 45/14

(52) U.S. Cl. CPC B29C 45/14065; B29C 2045/14147

(57) ABSTRACT

A positioning module and a mold insert thereof are provided. The positioning module for positioning an insert includes a lower mold disposed relatively below, an upper mold disposed relatively above and at least one mold insert. The mold insert includes an insert body, a positioning hole, at least one roller guide slot and at least one roller set. The positioning hole is formed in the insert body for the insert to pass through to be positioned. The roller guide slot is disposed at the insert body and partially communicates with the positioning hole. The roller set is disposed in the corresponding roller guide slot, and rolls in circular motion. When at a position where the corresponding roller guide slot communicates with the positioning hole, the roller set protrudes to the positioning hole to be in rolling contact with at least one side of the insert.

### CROSS-REFERENCE TO RELATED PATENT APPLICATION

This application claims the benefit of priority to P.R.C. Patent Application No. 201810150375.4, filed on Feb. 13, 2018. The entire content of the above identified application is incorporated herein by reference. Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to a mold module, and more particularly to a positioning module and a mold insert thereof.

### BACKGROUND OF THE DISCLOSURE

It is a common method of production to form a product by the insert molding. A molded product is such as a plug, a connector and a screwdriver. Generally, the insert is positioned in the mold by the mold module and the mold insert, and the mold insert is formed with a positioning hole for allowing the insert to pass through and be positioned. However, the surface of the insert is easily scratched when entering into and exiting from the positioning hole, which causes a product defect and reduces a yield rate of production. Therefore, a gap width of around 0.03 mm is arranged between the wall of the positioning hole and a side of the insert in the conventional method, which cannot solve the issue of surface scratches of the insert, and may even cause an issue that the insert cannot be positioned precisely. Accordingly, the yield rate of production and the mold precision cannot be improved by the conventional method.

### SUMMARY OF THE DISCLOSURE

The present disclosure is to provide a positioning module and a mold insert thereof.

In order to solve the aforementioned issues, one of the technical solutions applied by the present disclosure is to provide a positioning module for positioning at least one insert, including: a lower mold disposed relatively below; an upper mold disposed relatively above the lower mold; and at least one mold insert embedded in the upper mold, including: an insert body; a positioning hole formed in the insert body for the insert to pass through and be positioned; at least one roller guide slot disposed at the insert body and partially communicating with the positioning hole; and at least one roller set disposed in the corresponding roller guide slot and rolling in circular motion therein, wherein the roller set protrudes to the positioning hole at a position where the corresponding roller guide slot communicates with the positioning hole to be in rolling contact with at least one side of the insert.

Preferably, a gap width between a part of the roller set protruding to the positioning hole and a side of the insert is arranged to be 0.015 mm or less.

Preferably, the gap width between the part of the roller set protruding to the positioning hole and the side of the insert is arranged to be 0.01 mm.

Preferably, the roller guide slot is circular.

Preferably, the number of the roller guide slots and the number of the roller sets are two, one of the roller guide slots is disposed at a first side wall of the insert body such that one of the roller sets is correspondingly disposed in the roller guide slot at the first side wall of the insert body, and the other roller guide slot is disposed at a second side wall opposite to the first side wall of the insert body such that the other roller set is correspondingly disposed in the roller guide slot at the second side wall of the insert body.

Preferably, the number of the roller guide slots and the number of the roller sets are three, two of the roller guide slots are disposed side by side at the first side wall of the insert body such that two of the roller sets are disposed side by side in the two roller guide slots at the first side wall of the insert body, and the other roller guide slot is disposed at the second side wall opposite to the first side wall of the insert body such that the other roller set is disposed in the roller guide slot at the second side wall of the insert body.

Preferably, the number of the roller guide slots and the number of the roller sets are four, two of the roller guide slots are disposed side by side at the first side wall of the insert body such that two of the roller sets are disposed side by side in the two roller guide slots at the first side wall of the insert body, and the other two of the roller guide slots are disposed side by side at the second side wall opposite to the first side wall of the insert body such that the other two of the roller sets are disposed side by side in the roller guide slot at the second side wall of the insert body.

Preferably, the roller guide slot is formed with a circular path, the circular path includes two opposite straight paths and two opposite turning paths connecting with the two straight paths, the straight path is used to guide the roller set to move in a straight line, and the turning path is used to guide the roller set to veer.

Preferably, the straight path is disposed along a slide-in direction and a slide-out direction of the insert.

Preferably, the lower mold includes an auxiliary air passage extending from the top of the lower mold to the bottom of the lower mold so as to communicate with the outside, the insert body has air passage through holes corresponding to the number of the roller guide slots, and the air passage through holes respectively communicate with the auxiliary air passage and the corresponding roller guide slot.

Preferably, a negative pneumatic force is applied to the air passage through holes when the insert slides into the positioning hole.

Preferably, a positive pneumatic force is applied to the air passage through holes when the insert slides out of the positioning hole.

In order to solve the aforementioned issues, another technical solution applied by the present disclosure is to provide a mold insert, including: an insert body; a positioning hole formed in the insert body for an insert to pass through and be positioned; at least one roller guide slot disposed at the insert body and partially communicating with the positioning hole; and at least one roller set disposed in the corresponding roller guide slot and rolling in circular motion therein, wherein the roller set protrudes to the positioning hole at a position where the corresponding roller guide slot communicates with the positioning hole to be in rolling contact with at least one side of the insert.

Preferably, a gap width between a part of the roller set protruding to the positioning hole and a side of the insert is arranged to be 0.015 mm or less.

Preferably, the gap width between the part of the roller set protruding to the positioning hole and the side of the insert is arranged to be 0.01 mm.

Preferably, the roller guide slot is circular.

Preferably, the number of the roller guide slots and the number of the roller sets are two, one of the roller guide slots is disposed at a first side wall of the insert body such that one of the roller sets is correspondingly disposed in the roller guide slot at the first side wall of the insert body, and the other roller guide slot is disposed at a second side wall opposite to the first side wall of the insert body such that the other roller set is correspondingly disposed in the roller guide slot at the second side wall of the insert body.

Preferably, the number of the roller guide slots and the number of the roller sets are three, two of the roller guide slots are disposed side by side at a first side wall of the insert body such that two of the roller sets are disposed side by side in the two roller guide slots at the first side wall of the insert body, and the other roller guide slot is disposed at a second side wall opposite to the first side wall of the insert body such that the other roller set is disposed in the roller guide slot at the second side wall of the insert body.

Preferably, the number of the roller guide slots and the number of the roller sets are four, two of the roller guide slots are disposed side by side at the first side wall of the insert body such that two of the roller sets are disposed side by side in the two roller guide slots at the first side wall of the insert body, and the other two of the roller guide slots are disposed side by side at a second side wall opposite to the first side wall of the insert body such that the other two of the roller sets are disposed side by side in the roller guide slot at the second side wall of the insert body.

Preferably, the roller guide slot is formed with a circular path, the circular path includes two straight paths opposite to each other and two turning paths opposite to each other and connecting with the two straight paths, the straight path is used to guide the roller set to move in a straight line, and the turning path is used to guide the roller set to veer.

Preferably, the straight path is disposed along a slide-in direction and a slide-out direction of the insert.

Based on the above, the beneficial effects of the present disclosure lie in that with the rolling of the roller set, in an extremely small gap, the product defects of being scratched on the surface caused by relative movement of the mold insert and the insert can be reduced, and a yield rate of production can be effectively improved. At the same time, the air passage optimizes the rolling of the roller set and further improves the yield rate of production.

Further, the positioning precision is improved by the arrangement of the roller set which enables a gap width between a part of the roller set protruding to the positioning hole and a side of the insert to be arranged at 0.015 mm or less.

For further understanding the beneficial effects of the present disclosure, the detailed descriptions and drawings of the present disclosure are provided as follows.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the detailed description and the accompanying drawings, in which:

FIG. 1 is a perspective view of a positioning module positioning an insert according to the present disclosure;

FIG. 2 is a partially exploded view of FIG. 1;

FIG. 3 is a perspective view of a mold insert positioning the insert according to the present disclosure.

FIG. 4 is a perspective cross-sectional view of FIG. 3;

FIG. 5 is a perspective cross-sectional view from another angle of view of FIG. 4.

FIG. 6 is a cross-sectional view of FIG. 5;

FIG. 6A is a partially enlarged cross-sectional view of VIA of FIG. 6;

FIG. 6B is a partially enlarged cross-sectional view of VIB of FIG. 6;

FIG. 7 is a schematic view of an operation according to the present disclosure;

FIG. 8 is a schematic view of an operation according to the present disclosure;

FIG. 9 is a cross-sectional view of FIG. 1;

FIG. 10 is a schematic view of an operation according to the present disclosure; and

FIG. 11 is a schematic view of an operation according to the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. Like directions including left, right, above/upper and below/lower in the drawings indicate like references of directions throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

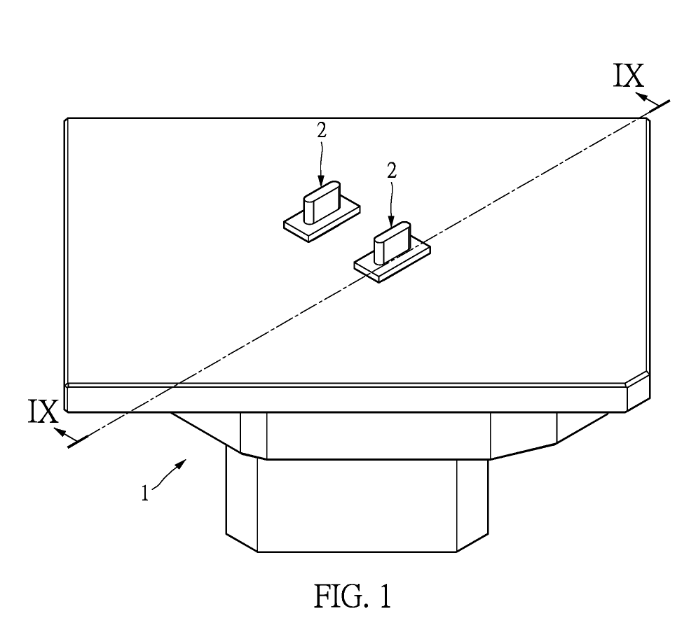

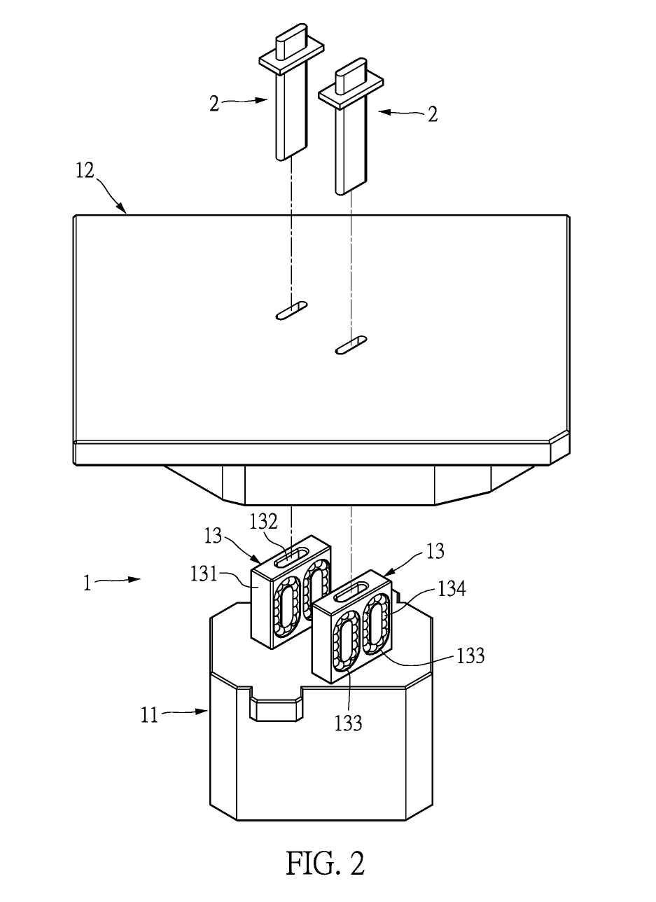

Referring to FIG. 1 and FIG. 2, an embodiment of the present disclosure provides a positioning module 1 in a mold for positioning at least one insert 2. The insert 2 may be a metal insert or an insert made of other non-plastic materials. In this embodiment, the insert 2 is a plug terminal made of metal. The positioning module 1 can be used to position two inserts 2 and integrally form the two metal inserts 2 with plastic into a plug by insert molding, but the embodiment does not limit the number of the metal insert 2 and a one-piece form of the plastic.

The positioning module 1 of the embodiment of the present disclosure may include a lower mold 11 disposed relatively below, an upper mold 12 disposed relatively above the lower mold, and at least one mold insert 13 embedded in the upper mold 12. In this embodiment, the positioning module 1 includes two mold inserts 13 embedded in the upper mold 12 and the number of the mold inserts 13 corresponds to the number of the insert 2. When the number of the insert 2 is one, the number of the mold insert 13 is one. In addition, the positioning module 1 positions the insert 2 by the mold insert 13.

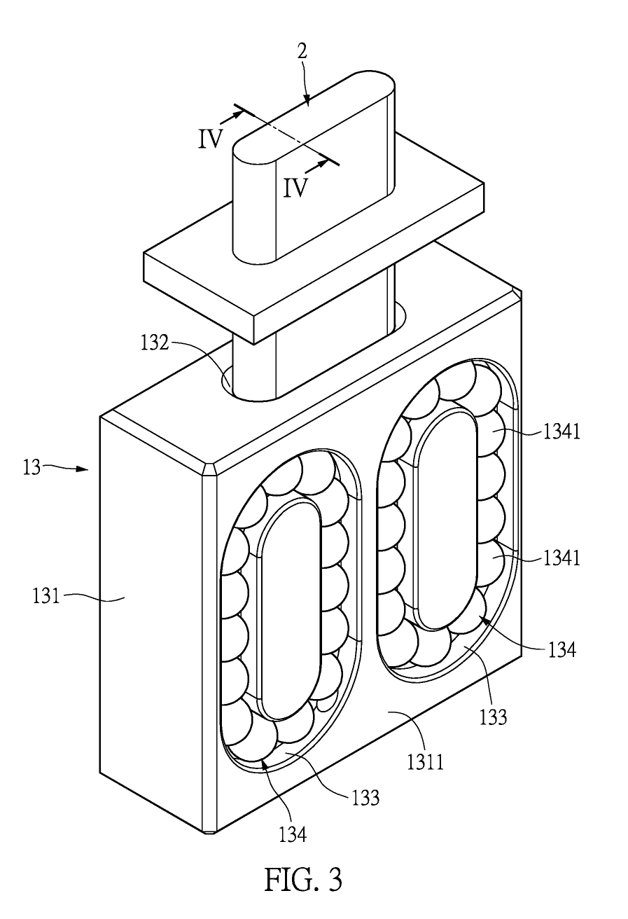

Further, referring to FIG. 3 to FIG. 6, for the sake of brevity, only one mold insert 13 and one insert 2 that cooperate with each other for positioning are shown.

The mold insert 13 includes an insert body 131, a positioning hole 132, four roller guide slots 133 and four roller sets 134. Although in the present disclosure, the embodiment discloses four roller guide slots 133 and four roller sets 134, the number of the roller guide slots 133 and the number of the roller sets 134 are not limited to four, and the number of the roller guide slots 133 and the number of the roller sets 134 can respectively be 1, 2, 3 or 5 or more. Further descriptions of the relationships between each component and the detailed features of the insert body 131, the positioning hole 132, the roller guide slot 133 and the roller set 134 of the embodiment of the present disclosure will be provided as follows.

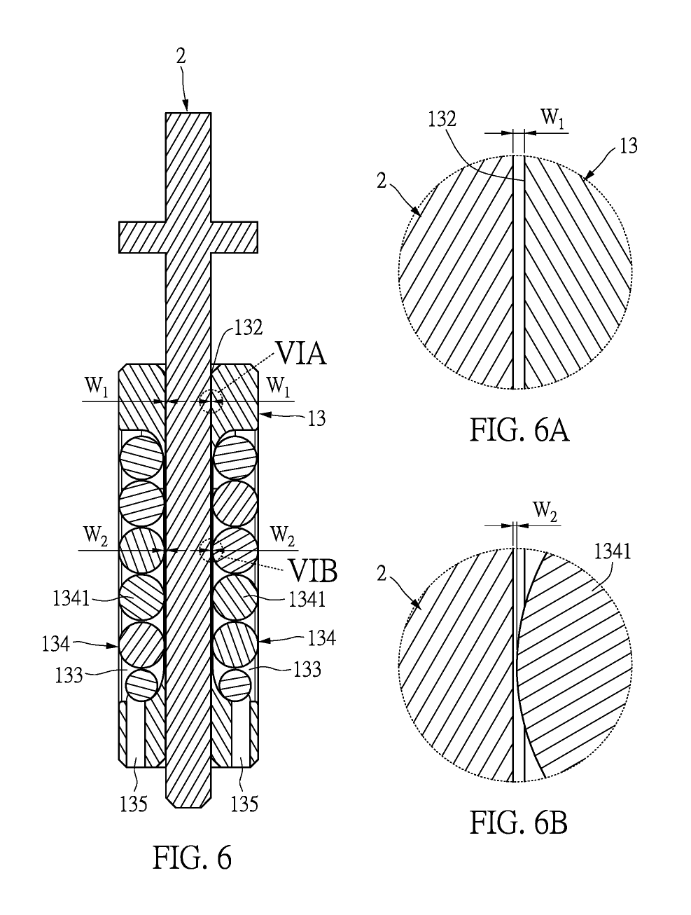

In this embodiment, the positioning hole 132 vertically penetrates the insert body 131 for the insert 2 to pass through for positioning. However, in other embodiments, the positioning hole 132 may be a blind hole without penetrating the insert body 131. In order to improve the processing precision, the positioning hole 132 is processed by, for example, wire-cutting, and a shape of the positioning hole 132 corresponding to that of the insert 2. In this embodiment, a gap width W1 between a wall of the positioning hole 132 and a side of the insert 2 is arranged to be around 0.03 mm as shown in FIG. 6 and FIG. 6A. It should be specifically noted that the gap width W1 between the wall of the positioning hole 132 and the side of the insert 2 refers to a distance between the side wall of the insert 2 and the wall of the positioning hole 132 when the insert 2 is inserted in the center of the positioning hole 132.

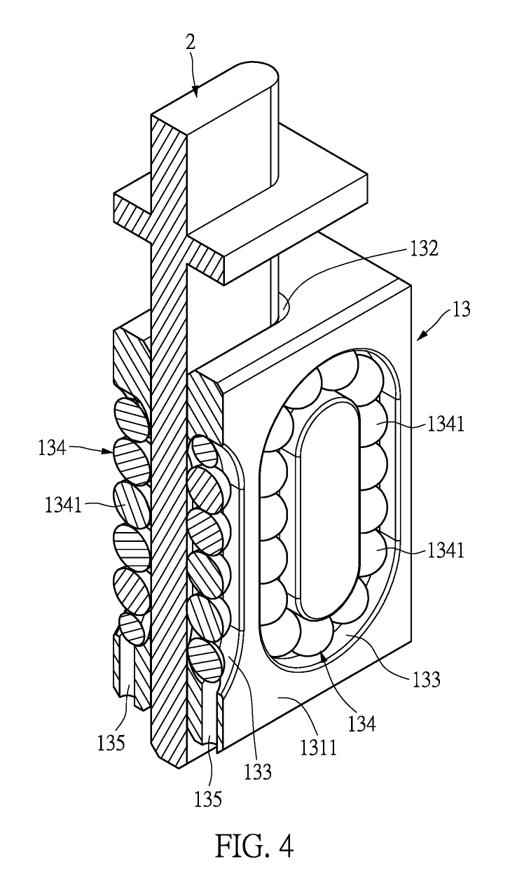

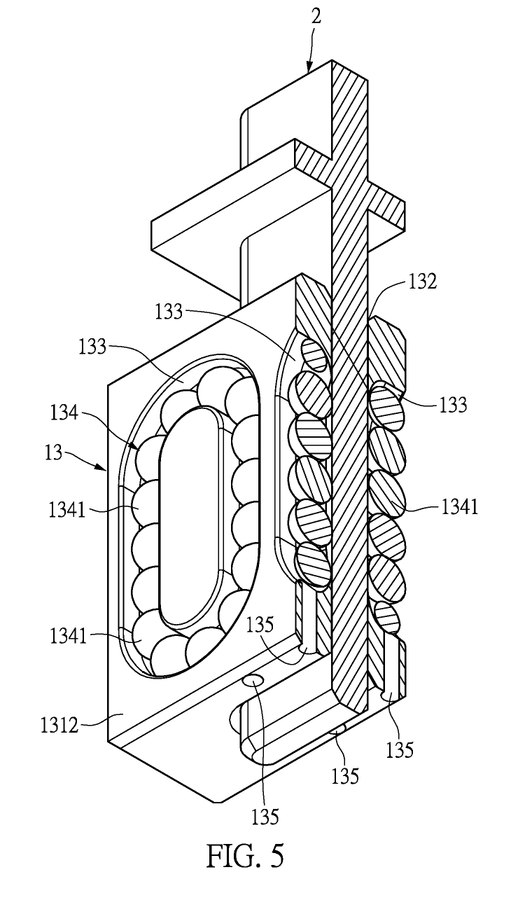

Two of the four roller guide slots 133 are disposed at a first side wall 1311 of the insert body 131 as shown in FIG. 4, the other two roller guide slots 133 are disclosed at a second side wall 1312 opposite to the first side wall 1311 of the insert body 131 as shown in FIG. 5, and the four roller guide slots 133 partially communicate with the positioning hole 132, respectively.

The four roller sets 134 are respectively disposed in the corresponding four roller guide slots 133, and roll in circular motion therein. Since the roller guide slots 133 partially communicate with the positioning hole 132, when the roller sets 134 are at positions where the roller guide slots 133 communicate with the positioning hole 132, the roller sets 134 can protrude to the positioning hole 132 to be in rolling contact with the insert 2. In detail, each roller set 134 includes a plurality of rollers, which may be balls or roller bearings. In this embodiment, each roller set 134 includes 15 balls 1341, but the number of the balls 1341 can be adjusted according to particular implementations. A liquid lubricant may be used between each ball 1341 to reduce friction when moving. Alternatively, each ball 1341 may be a self-lubricating ball processed from a steel material coated with tungsten disulfide such that the liquid lubricant may not be required. Further, with the arrangement of the balls 1341, a gap width W2 between the balls 1341 protruding to the positioning hole 132 and a side of the insert 2 is arranged to be 0.015 mm or less as shown in FIG. 6 and FIG. 6B, and preferably 0.01 mm. Compared with a gap width between a positioning hole and a side of the insert in the related art, which is about 0.03 mm, the gap width W2 may improve the positioning precision. In addition, when the insert 2 enters or exits from the positioning hole 132, the balls 1341 are in rolling contact with a surface of the insert 2. In this way, in an extremely small gap of 0.015 mm or less, product defects caused by scratches on the surface of the insert 2 can be reduced and a yield rate of production can be improved. It should be noted that the gap width W2 between the balls 1341 and the side of the insert 2 refers to a distance between the balls 1341 protruding from the roller guide slots 133 to the positioning hole 132 and the insert 2 when the insert 2 is inserted in the center of the positioning hole 132.

Further, the roller guide slots 133 are circular, and two of the roller guide sets 133 are disposed side by side at the first side wall 1311 of the insert body 131, such that two of the roller sets 134 are correspondingly disposed side by side in the two roller guide slots 133 at the first side wall 1311 of the insert body 131, and the other two roller guide sets 133 are also disposed side by side at the second side wall 1312 opposite to the first side wall 1311 of the insert body 131, such that the other two roller sets 134 are correspondingly disposed side by side in the two roller guide slot 133 at the second side wall 1312 of the insert body 131.

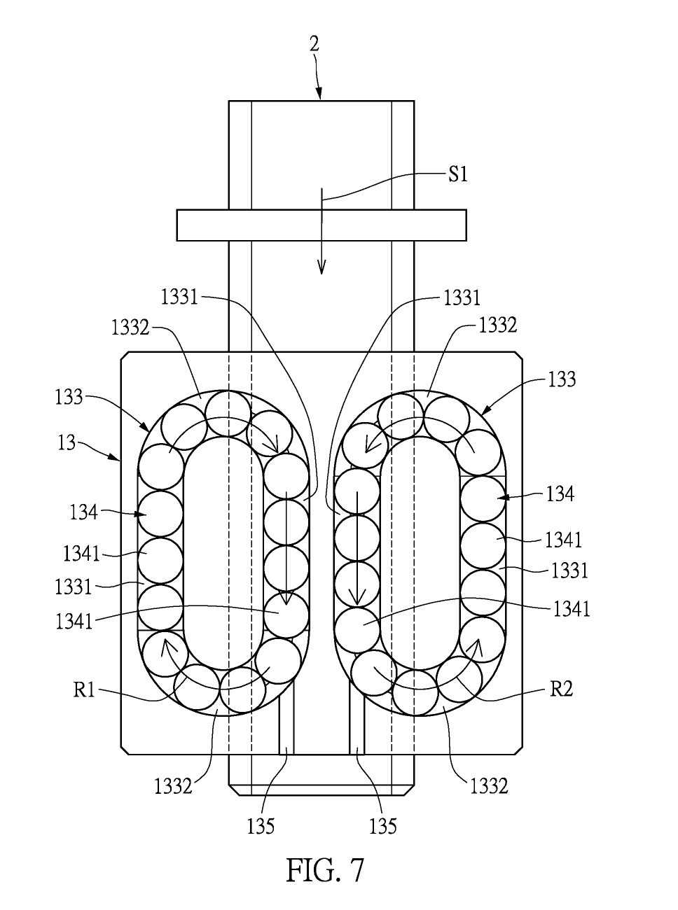

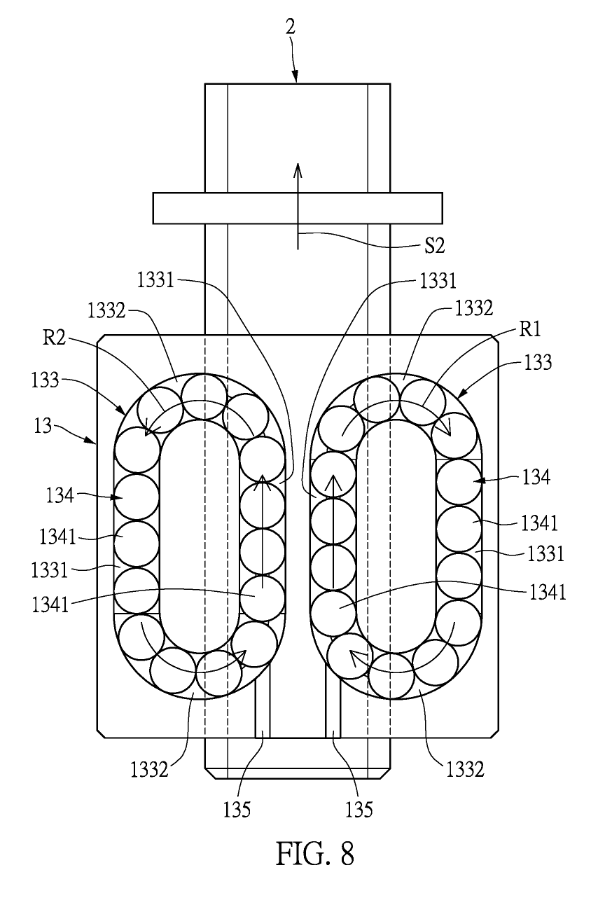

Referring to FIG. 7 and FIG. 8, the circular roller guide slot 133 has a circular path including two opposite straight paths 1331 and two opposite turning paths 1332 connected with the two straight paths 1331. The straight path 1331 guides the roller set 134 to move in a straight line, and the turning path 1332 guides the roller set 134 to veer so that the roller set 134 can circularly roll along the circular path in the roller guide set 133. Furthermore, the adjacent straight paths 1331 of the two side by side roller guide slots 133 are disposed along a slide-in direction S1 and a slide-out direction S2 of the insert 2. In other words, the straight paths 1331 are disposed along a long axis direction of the positioning hole 132. Therefore, when the insert 2 enters the positioning hole 132 along the slide-in direction S1 as shown in FIG. 7, the balls 1341 located at a position where the roller guide slots 133 communicate with the positioning hole 132 can be pulled upward by the insert 2 to roll. At the same time, the balls 1341 roll along the slide-out direction S2 and can then respectively roll in a counterclockwise direction R2 or a clockwise direction R1, respectively, such that the insert 2 can smoothly exit from the positioning hole 132 along the slide-out direction S2.

It should be noted that FIG. 7 and FIG. 8 merely illustrate the operation of the two roller sets 134 in the roller guide slots 133 at the first side wall 1311 of the insert body 131. It should be understandable that the operation of the other two roller sets 134 in the roller guide slots 133 at the second side wall 1312 of the insert body 131 is the same as the operation illustrated in FIG. 7 and FIG. 8, and should be omitted herein.

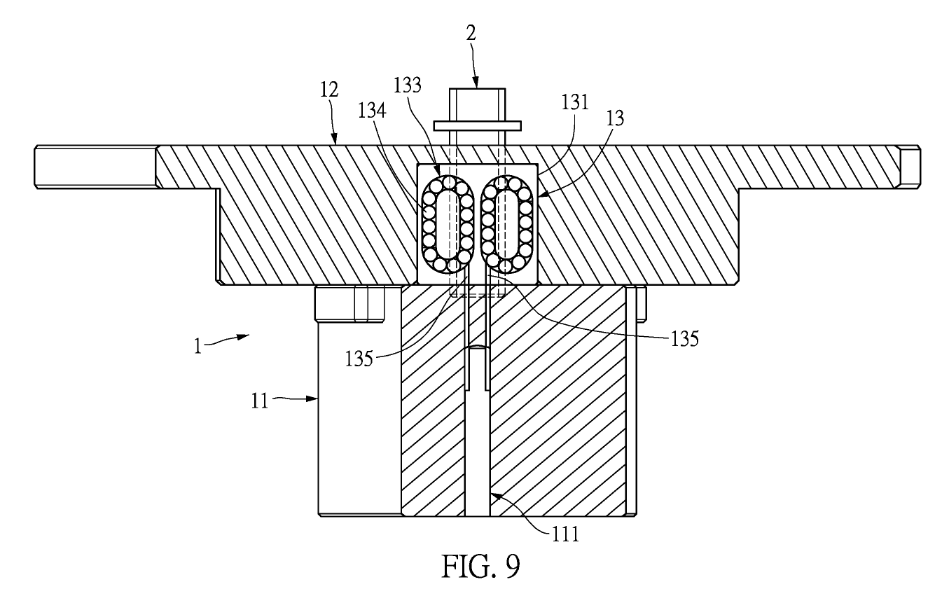

In addition, referring to FIGS. 1-2 and FIGS. 9-11, the lower mold 11 may include an auxiliary air passage 111 extending from the top of the lower mold 11 to the bottom of the lower mold 11 so as to communicate with the outside, the insert body 131 of the mold insert 13 can be disposed with air passage through holes 135 corresponding to the number of the roller guide slots 133, and the air passage through holes 135 respectively communicate with the auxiliary air passage 111 and the corresponding roller guide slot 133.

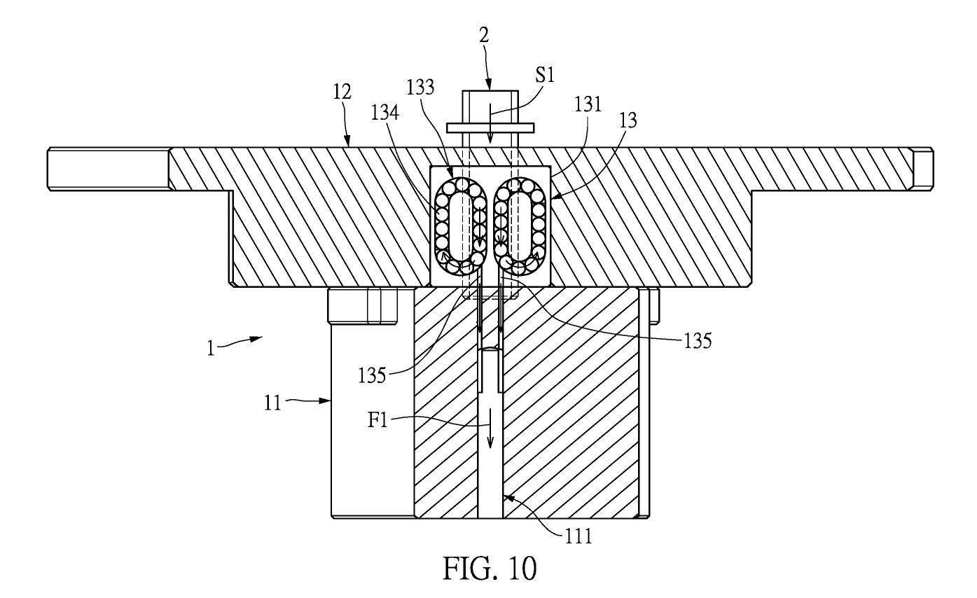

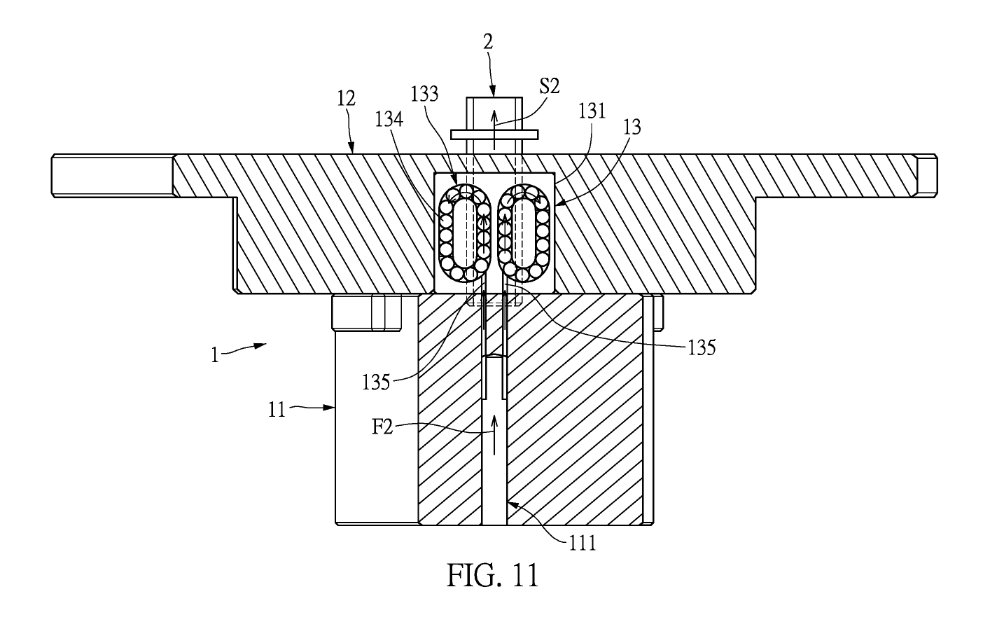

In this embodiment, the insert body 131 can be provided with four air passage through holes 135 to respectively communicate with the four roller guide slots 133. The number of the air passage through holes 135 corresponds to the number the roller guide slots 133 to optimize the rolling of the roller sets 134 in the roller guide slots 133. When the insert 2 enters the positioning hole 132 along the slide-in direction S1 as shown in FIG. 10, a negative pneumatic force F1 is applied to each of the air passage through holes 135 by the auxiliary air passage 111. In this way, each of the air passage through holes 135 sucks air to assist the roller sets 134 in the two side by side roller guide slots 133 to simultaneously roll along the slide-in direction S1 and then respectively roll in the clockwise direction or the counterclockwise direction. After molding, when the insert 2 exits from the positioning hole 132 along the slide-out direction S2 as shown in FIG. 11, a positive pneumatic force F2 is applied to each of the air passage through holes 135 by the auxiliary air passage 111. In this way, each of the air passage through holes 135 expels air to assist the roller sets 134 in the two side by side roller guide slots 133 to simultaneously roll along the slide-out direction S2 and then respectively roll in the counterclockwise direction or the clockwise direction. The negative pneumatic force F1 and the positive pneumatic force F2 can be realized by an air pump. Accordingly, with the air passage, the rolling of the balls can be further optimized so as to improve the yield rate of production.

It should be noted that FIG. 10 and FIG. 11 merely illustrate the configuration of the two air passage through holes 135 at the first side wall 1311 of the insert body 131. It should be understandable that the configuration of the other two air passage through holes 135 at the second side wall 1312 of the insert body 131 is the same as the state illustrated in FIG. 10 and FIG. 11, and should be omitted herein.

In summary, the present disclosure can at least achieve the following beneficial effects: with the roller set, the gap width between the roller set protruding to the positioning hole and the insert is 0.015 mm or less. Compared with the conventional gap width of about 0.03 mm, the gap width of the present disclosure can effectively improve the position precision. Further, with the roller set, in an extremely small gap, the product defects of being scratched on the surface caused by relative movement of the mold insert and the insert can be reduced, and a yield rate of production can be effectively improved. At the same time, the air passage optimizes the rolling of the roller set and further improves the yield rate of production.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A positioning module for positioning at least one insert, comprising:
a lower mold disposed relatively below;
an upper mold disposed relatively above the lower mold; and
at least one mold insert embedded in the upper mold, including:
an insert body;
a positioning hole formed in the insert body for the insert to pass through to be positioned;
at least one roller guide slot disposed at the insert body and partially communicating with the positioning hole; and
at least one roller set disposed in the corresponding roller guide slot, rolling in circular motion therein, wherein the roller set protrudes to the positioning hole at a position where the corresponding roller guide slot communicates with the positioning hole to be in rolling contact with at least one side of the insert.

2. The positioning module according to claim 1, wherein a gap width between a part of the roller set protruding to the positioning hole and a side of the insert is 0.015 mm or less.

3. The positioning module according to claim 2, wherein the gap width between the part of the roller set protruding to the positioning hole and the side of the insert is 0.01 mm.

4. The positioning module according to claim 1, wherein the roller guide slot is circular.

5. The positioning module according to claim 1, wherein the number of the roller guide slots and the number of the roller sets are two, one of the roller guide slots is disposed at a first side wall of the insert body such that one of the roller sets is correspondingly disposed in the roller guide slot at the first side wall of the insert body, and the other roller guide slot is disposed at a second side wall opposite to the first side wall of the insert body such that the other roller set is correspondingly disposed in the roller guide slot at the second side wall of the insert body.

6. The positioning module according to claim 1, wherein the number of the roller guide slots and the number of the roller sets are three, two of the roller guide slots are disposed side by side at a first side wall of the insert body such that two of the roller sets are disposed side by side in the two roller guide slots at the first side wall of the insert body, and the other roller guide slot is disposed at a second side wall opposite to the first side wall of the insert body such that the other roller set is disposed in the roller guide slot at the second side wall of the insert body.

7. The positioning module according to claim 1, wherein the number of the roller guide slots and the number of the roller sets are four, two of the roller guide slots are disposed side by side at a first side wall of the insert body such that two of the roller sets are disposed side by side in the two roller guide slots at the first side wall of the insert body, and the other two of the roller guide slots are disposed side by side at a second side wall opposite to the first side wall of the insert body such that the other two of the roller sets are disposed side by side in the roller guide slot at the second side wall of the insert body.

8. The positioning module according to claim 4, wherein the roller guide slot is formed with a circular path, the circular path includes two opposite straight paths and two opposite turning paths connecting with the two straight paths, the straight path is used to guide the roller set to move in a straight line, and the turning path is used to guide the roller set to veer.

9. The positioning module according to claim 8, wherein the straight path is disposed along a slide-in direction and a slide-out direction of the insert.

10. The positioning module according to claim 1, wherein the lower mold includes an auxiliary air passage extending from the top of the lower mold to the bottom of the lower mold so as to communicate with the outside, the insert body has air passage through holes corresponding to the number of the roller guide slots, and the air passage through holes respectively communicate with the auxiliary air passage and the corresponding roller guide slot.

11. The positioning module according to claim 10, wherein a negative pneumatic force is applied to the air passage through hole when the insert slides into the positioning hole and a positive pneumatic force is applied to the air passage through hole when the insert slides out of the positioning hole.

12. A mold insert, comprising:
an insert body;
a positioning hole formed in the insert body for an insert to pass through to be positioned;
at least one roller guide slot disposed at the insert body and partially communicating with the positioning hole; and
at least one roller set disposed in the corresponding roller guide slot, rolling in circular motion therein, wherein the roller set protrudes to the positioning hole at a position where the corresponding roller guide slot communicates with the positioning hole to be in rolling contact with at least one side of the insert.

13. The mold insert according to claim 12, wherein a gap width between a part of the roller set protruding to the positioning hole and a side of the insert is 0.015 mm or less.

14. The mold insert according to claim 13, wherein the gap width between the part of the roller set protruding to the positioning hole and the side of the insert is 0.01 mm.

15. The mold insert according to claim 12, wherein the roller guide slot is circular.

16. The mold insert according to claim 12, wherein the number of the roller guide slots and the number of the roller sets are two, one of the roller guide slots is disposed at a first side wall of the insert body such that one of the roller sets is correspondingly disposed in the roller guide slot at the first side wall of the insert body, and the other roller guide slot is disposed at a second side wall opposite to the first side wall of the insert body such that the other roller set is correspondingly disposed in the roller guide slot at the second side wall of the insert body.

17. The mold insert according to claim 12, wherein the number of the roller guide slots and the number of the roller sets are three, two of the roller guide slots are disposed side by side at a first side wall of the insert body such that two of the roller sets are disposed side by side in the two roller guide slots at the first side wall of the insert body, and the other roller guide slot is disposed at a second side wall opposite to the first side wall of the insert body such that the other roller set is disposed in the roller guide slot at the second side wall of the insert body.

18. The mold insert according to claim 12, wherein the number of the roller guide slots and the number of the roller sets are four, two of the roller guide slots are disposed side by side at a first side wall of the insert body such that two of the roller sets are disposed side by side in the two roller guide slots at the first side wall of the insert body, and the other two of the roller guide slots are disposed side by side at a second side wall opposite to the first side wall of the insert body such that the other two of the roller sets are disposed side by side in the roller guide slot at the second side wall of the insert body.

19. The mold insert according to claim 15, wherein the roller guide slot is formed with a circular path, the circular path includes two opposite straight paths and two opposite turning paths connecting with the two straight paths, the straight path is used to guide the roller set to move in a straight line, and the turning path is used to guide the roller set to veer.

20. The mold insert according to claim 19, wherein the straight path is disposed along a slide-in direction and a slide-out direction of the insert.
